(19) United States
(12) Patent Application Publication
(10) Pub. No.: US 2017/0236151 A1
(43) Pub. Date: Aug. 17, 2017

(54) SYSTEMS, DEVICES, AND METHODS OF PROVIDING TARGETED ADVERTISING

(71) Applicant: GB Media, Inc., New Orleans, LA (US)

(72) Inventors: Staacy Cannon, New Orleans, LA (US); Nicole Mast, New Orleans, LA (US); Rachel Thomas, New Orleans, LA (US); Chris Burrus, New Orleans, LA (US); John Benjamin Wisalowski, New Orleans, LA (US)

(21) Appl. No.: 15/429,775

(22) Filed: Feb. 10, 2017

Related U.S. Application Data
(60) Provisional application No. 62/294,537, filed on Feb. 12, 2016.

(51) Int. Cl. G06Q 30/02; G06T 7/00; G06K 9/32; H04N 7/18

(52) U.S. Cl. CPC G06Q 30/0251; H04N 7/183; G06T 7/0004; G06K 9/325; G06T 2207/30108; G06T 2207/30196

(57) ABSTRACT

Advertising systems, advertising devices, and methods for providing a targeted ad are described. An advertising system includes an advertising channel, one or more imaging devices that obtain image data containing images captured at or near an advertising channel, and a computing device. The computing device analyzes the image data to determine that one or more individuals are present at or near the advertising channel, determines that at least one individual of the one or more individuals present at or near the advertising channel are engaged with the advertising channel, and determines at least one of one or more demographic features of the at least one individual, and one or more psychographic features of the at least one individual. The advertising channel provides a targeted ad to the at least one individual based on at least one of the one or more demographic features of the at least one individual and the one or more psychographic features of the at least one individual.

### CROSS-REFERENCE TO RELATED APPLICATION

The present application claims priority to U.S. Provisional Patent Application Ser. No. 62/294,537, filed Feb. 12, 2016 and entitled “Systems, Devices, and Methods of Providing Targeted Advertising,” the entire contents of which is incorporated herein by reference.

### TECHNICAL FIELD

The present specification generally relates to systems, devices, and methods for monitoring and analyzing users to provide targeted advertising and, more specifically, to systems, devices, and methods that use intelligence regarding individual users that view a particular advertising channel to provide relevant advertising.

### BACKGROUND

When companies undergo an advertising campaign, they may desire to provide targeted advertising to consumers to ensure that a consumer is provided with an ad or a version of the ad that is most likely to have an impact on the consumer. In addition, a company may desire to only provide advertising to one or more individuals that are paying attention to an advertising channel so as to ensure that the targeted ad is viewed by the individual.

Current targeted ads do not account for certain demographic and/or psychographic information regarding a consumer, or may not accurately determine certain demographic and/or psychographic information regarding the consumer. In addition, current targeted ads do not account for whether a consumer is engaged with an advertising channel, which results in targeted ads being displayed to individuals that are not paying attention.

Accordingly, a need exists for systems and methods that provide targeted advertising that only reaches individuals that are actively engaged with an advertising channel and for which particular demographic and/or psychographic information has been determined.

### SUMMARY

In one embodiment, an advertising system includes an advertising channel, one or more imaging devices that obtain image data containing images captured at or near an advertising channel, and a computing device. The computing device analyzes the image data to determine that one or more individuals are present at or near the advertising channel, determines that that at least one individual of the one or more individuals present at or near the advertising channel are engaged with the advertising channel, and determines at least one of one or more demographic features of the at least one individual, and one or more psychographic features of the at least one individual. The advertising channel provides a targeted ad to the at least one individual based on at least one of the one or more demographic features of the at least one individual and the one or more psychographic features of the at least one individual.

In another embodiment, an advertising device includes a processing device and a non-transitory, processor-readable storage medium. The non-transitory, processor-readable storage medium comprises one or more programming instructions thereon that, when executed, cause the processing device to receive image data from one or more imaging devices, where the image data contains images captured at or near an advertising channel, analyze the image data to determine that one or more individuals are present at or near the advertising channel, determine that that at least one individual of the one or more individuals present at or near the advertising channel is engaged with the advertising channel, determine at least one of one or more demographic features of the at least one individual and one or more psychographic features of the at least one individual, and provide a targeted ad to the at least one individual based on at least one of the one or more demographic features of the at least one individual and the one or more psychographic features of the at least one individual.

In yet another embodiment, a method of providing a targeted ad to an individual includes receiving, by a processing device, image data from one or more imaging devices, where the image data contains images captured at or near an advertising channel, analyzing, by the processing device, the image data to determine that one or more individuals are present at or near the advertising channel, determining, by the processing device, that at least one individual of the one or more individuals present at or near the advertising channel is engaged with the advertising channel, determining, by the processing device, at least one of one or more demographic features of the at least one individual and one or more psychographic features of the at least one individual, and providing, by the processing device, a targeted ad to the at least one individual based on at least one of the one or more demographic features of the at least one individual and the one or more psychographic features of the at least one individual.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a block diagram of the various components of an illustrative advertising system according to one or more embodiments shown and described herein;

FIG. 2 schematically depicts a block diagram of illustrative computer processing hardware components according to one or more embodiments shown and described herein; and

FIG. 3 schematically depicts a viewing area of an illustrative imaging device according to one or more embodiments shown and described herein;

FIG. 4A depicts an illustrative face recognized by one or more components of the advertising system of FIG. 1 according to one or more embodiments shown and described herein;

FIG. 4B depicts another illustrative face recognized by one or more components of the advertising system of FIG. 1 according to one or more embodiments shown and described herein;

FIG. 4C depicts yet another illustrative face recognized by one or more components of the advertising system of FIG. 1 according to one or more embodiments shown and described herein;

FIG. 5 depicts a flow diagram of an illustrative method of displaying targeted advertising to an individual according to one or more embodiments shown and described herein; and

FIG. 6 schematically depicts a flow diagram of an illustrative method of determining a subset of engaged users according to one or more embodiments shown and described herein.

### DETAILED DESCRIPTION

The embodiments described herein are generally directed to systems and methods that capture image data at or near an advertising channel, determine whether individuals present in the image data are engaged, determine corresponding demographic and/or psychographic features of an engaged individual, and provide targeted advertising to the individual based on the demographic and/or psychographic features.

As used herein, an “advertising channel” generally refers to any system or device that provides an advertisement, particularly an advertisement that is situated such that a plurality of individuals have an opportunity to view the advertisement. The advertising channel may refer to a single advertising location or a plurality of locations (e.g., the same type of advertisement provided at a plurality of different advertising locations).

In some embodiments, the advertising channel may be an out-of-home advertising channel. That is, the advertisement is at a location that is not within a private location, such as, for example, a person's home, private offices, and/or the like. In addition, the advertisement may not be located on an individual or entity's private electronic device, such as, for example, a television, a computer, a portable electronic device, and/or the like. An illustrative out-of-home advertising channel may include, but is not limited to, a poster, a billboard, and a wall scape. For example, the poster may be a wall poster for advertising a product such as a movie or the like, a poster located on or in public transit vehicles, a poster located at a bus stop, and/or the like. In another example, the billboard may be a highway sign, a large sign in a highly trafficked area, a sign at or near a parking garage, and/or the like. In yet another example, a wall scape may be a billboard or similar advertisement (e.g., a banner) that is presented on the side of a building, particularly a building in a landmark location in a city. Out-of-home advertising channels may provide still images, video images, interactive displays, or a combination thereof. Other out-of-home advertising channels not specifically described herein should be understood as being included within the scope of the present disclosure.

In some embodiments, the advertising channel may be an in-home advertising channel. That is, the advertisement may be provided to an individual or entity's private device and/or provided in a private location such as a person's home, private offices, and/or the like. In such embodiments, the advertising channel may use a private device to obtain image data and process the image data before transmitting to a remote computing device, as described in greater detail herein. In-home advertising channels may provide still images, video images, or a combination thereof. It should be understood that other in-home advertising channels not specifically described herein are included within the scope of the present disclosure.

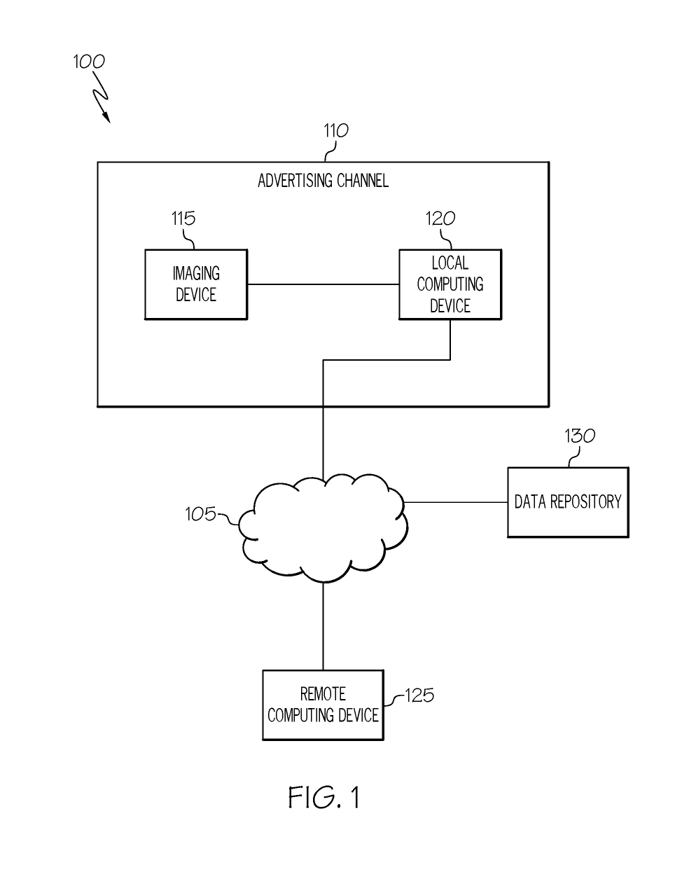

Referring now to the figures, FIG. 1 depicts a block diagram of the various components of an advertising system 100. The advertising system 100 may generally include a computer network 105. As illustrated in FIG. 1, the computer network 105 may include a wide area network (WAN), such as the Internet, an intranet, a local area network (LAN), a mobile communications network, a public service telephone network (PSTN), a personal area network (PAN), a metropolitan area network (MAN), a virtual private network (VPN), and/or another network. The computer network 105 may be configured to communicatively connect one or more computing devices and/or components thereof. Illustrative computing devices may include, but are not limited to, a local computing device 120 and a remote computing device 125. In some embodiments, the computer network 105 may also connect a data repository 130.

The local computing device 120 refers generally to a computing device that is positioned at or near an advertising channel 110. As such, the local computing device 120 is local in the sense that it is local to the advertising channel 110. That is, the local computing device 120 is generally within a vicinity of the advertising channel 110. For example, in some embodiments, the local computing device 120 may be embedded in the advertising channel 110. In other embodiments, the local computing device 120 may be physically coupled to the advertising channel 110, such as, for example, an existing advertising channel 110 that has been retrofitted with the local computing device 120. In some embodiments, the local computing device 120 may be positioned and/or arranged such that the local computing device 120 is communicatively coupled to the advertising channel 110.

In various embodiments, the local computing device 120 may be communicatively coupled to an imaging device 115 via any wired or wireless means now known or later developed. Thus, the local computing device 120 may be communicatively coupled to the imaging device 115 via one or more wires, cables, and/or the like, or may be coupled via a secure wireless connection using one or more wireless radios, such as, for example, Bluetooth, an 802.11 standard, near field communication (NFC), and/or the like. In some embodiments, the local computing device 120 may be communicatively coupled to the imaging device 115 via a wired means to avoid interception of signals and/or data transmitted between the imaging device 115 and the local computing device 120 so as to provide an enhanced security measure that protects privacy of individuals whose images are obtained by the imaging device 115, as described in greater detail herein. As also described in greater detail herein, the imaging device 115 and the local computing device 120 may be communicatively coupled such that data, such as image data or the like, can be transmitted between the imaging device 115 and the local computing device 120.

In some embodiments, the imaging device 115 may be integrated with the local computing device 120 (e.g., a component of the local computing device 120). In other embodiments, the imaging device 115 may be a standalone device that is separate from the local computing device 120. In some embodiments, the imaging device 115 and the local computing device 120 may be combined into a single unit that is integrated with the advertising channel 110.

The imaging device 115 is not limited by this disclosure, and may generally be any device that captures images. In some embodiments, the imaging device 115 may be a camera, camcorder, or the like, and may incorporate one or more image sensors, one or more image processors, one or more optical elements, and/or the like. In some embodiments, the imaging device 115 may be capable of focusing on a target object, zooming in and out, and/or moving, such as, for example, panning, tilting, and/or the like. In some embodiments, the imaging device 115 may be capable of tracking a moving object, such as, for example, an individual moving at or near the advertising channel 110, a vehicle moving near the advertising channel 110, and/or the like. As such, the imaging device 115 may incorporate various motion sensing and/or tracking components, software, and/or the like that are generally understood as providing tracking capabilities. In some embodiments, movement of the imaging device 115 may be remotely controlled by a user. In some embodiments, the imaging device 115 may incorporate one or more other imaging-related features such as, for example, one or more motion sensors. For example, the imaging device 115 may generally be in an inactive state (not recording activity), and activate when one or more motion sensors incorporated therewith detect movement.

While FIG. 1 depicts a single imaging device 115, it should be understood that any number of imaging devices may be used without departing from the scope of the present disclosure. For example, the imaging device 115 may be a plurality of imaging devices arranged to capture an image in tandem, such as, for example, to capture a larger field of view than what would be possible with a single imaging device 115 or to capture a plurality of different angles of the same field of view. In another example, a plurality of imaging devices 115 may be used to capture various angles of a particular area at or near the advertising channel 110. In yet another example, a plurality of imaging devices 115 may be positioned to capture various specific areas within a more general area, such as various entry and exit points of a parking structure or the like.

In some embodiments, the imaging device 115 may capture high dynamic range (HDR) images. In some embodiments, the imaging device 115 may capture a plurality of images successively (e.g., “burst mode” capture), may capture single images at particular intervals, and/or may capture motion images (e.g., video capture). In embodiments where images are captured at particular intervals, illustrative intervals may include, but are not limited to, every second, every 2 seconds, every 3 seconds, every 4 seconds, every minute, every 2 minutes, every 5 minutes, every 30 minutes, every hour, or the like. In addition to capturing images, the imaging device 115 may record information regarding the image capture, such as, for example, a time stamp of when the image was captured, a frame rate, a field of view, and/or the like. Each captured image and the recorded information may be transmitted as image data to the local computing device 120.

The local computing device 120 may be configured to receive the image data from the imaging device 115, process the image data to determine whether the image data contains engaged individuals, determine whether any engaged individuals possess any demographic and/or psychographic features, direct the advertising channel to display targeted advertising, interface with external devices (e.g., computers, databases, and/or the like) and/or provide information, as described in greater detail herein.

As the local computing device 120 and the imaging device 115 are located at or near the advertising channel 110, it should be understood that, in some embodiments, the advertising channel 110 may be a single unit that incorporates an advertising display, the local computing device 120, and the imaging device 115. In some embodiments, the advertising channel 110 may be particularly designed and configured for providing an advertisement. For example, the advertising channel 110 may be a billboard that incorporates the local computing device 120 and the imaging device 115. In other embodiments, the advertising channel 110 may be a device that can be used for other purposes. For example, the advertising channel 110 may be a portable electronic device such as a smartphone, a tablet, or a phablet that incorporates, among other components, a display, the imaging device 115, and the local computing device 120. In addition, the portable electronic device may contain program instructions (e.g., software) that provides the portable electronic device with functionality to operate as the advertising channel 110.

While a single advertising channel 110 is depicted in FIG. 1, it should be understood that a plurality of advertising channels 110 (each containing an imaging device 115 and a local computing device 120 associated therewith) may be connected to the computer network 105 without departing from the scope of the present disclosure. For example, as described in greater detail herein, the remote computing device 125 may interface with a plurality of advertising channels 110 to obtain information regarding whether each advertising channel 110 is successful or unsuccessful so that advertising funding can be adjusted towards successful advertising channels 110.

The remote computing device 125 may generally be a computing device that is positioned at a location that is remote to the local computing device 120 and the advertising channel 110. The remote computing device 125 may interface with the local computing device 120 over the computer network 105 via any wired or wireless connection now known or later developed, such as the various wired or wireless connections described herein. In addition to receiving data from the local computing device 120, the remote computing device 125 may transmit data to the local computing device 120 and may further interface with the data repository 130 coupled thereto.

While FIG. 1 depicts a single local computing device 120 and a single remote computing device 125, it should be understood that each computing device may embody a plurality of computing devices without departing from the scope of the present disclosure. For example, the remote computing device 125 may receive data from a plurality of local computing devices 120, such as a computing device located at each of a plurality of advertising channels 110.

The data repository 130 may generally be a data storage device, such as a data server, a cloud-based sever, a physical storage device, a removable media storage device, or the like. The data repository 130 may be integrated with the remote computing device 125 and/or the local computing device 120 (e.g., a component of the remote computing device 125 and/or the local computing device 120) or may be a standalone unit. In addition, while FIG. 1 depicts a single data repository 130, it should be understood that a plurality of data repositories may be used without departing from the scope of the present disclosure. The data repository 130 may generally receive data from one or more sources, such as the remote computing device 125, and store the data. In addition, the data repository 130 may selectively provide access to the data and/or transmit the data, such as to the local computing device 120. Illustrative data that may be stored in the data repository 130 may include image data, data relating to demographic features of an individual, data relating to psychographic features of an individual, targeted advertising data, and/or the like, as described in greater detail herein. In some embodiments, the data repository 130 may include advertisement data, such as data provided by advertisers that can be displayed as an advertisement at the advertising channel 110. In some embodiments, the data repository 130 may include data that allows the remote computing device 125 and/or the local computing device 120 to determine various demographics and psychographics, as described herein. For example, the data repository 130 may include a vehicle identification database that cross-references license plate information with the make, model, and type of vehicle associated with that license plate for the purposes of obtaining demographic and/or psychographic information therefrom. In another example, the data repository may include a brand identification database that allows the remote computing device 125 and/or the local computing device 120 to determine particular brands that are associated by a user (e.g., logos that appear on apparel worn by a user, logos on items carried by a user, logos on vehicles driven by a user, and/or the like). Such particular brands may be used for the purposes of obtaining demographic and/or psychographic information, as described in greater detail herein.

Any of the computing devices shown in FIG. 1 may include one or more hardware components thereof. For example, the local computing device 120 may contain one or more hardware components that allow the local computing device 120 to receive image data from the imaging device 115, process the image data to determine whether the image data contains engaged individuals, determine whether any engaged individuals possess any demographic and/or psychographic features, direct the advertising channel to display targeted advertising, and/or provide information to an individual. In another example, the remote computing device 125 may contain one or more hardware components that allow the remote computing device 125 to receive data from the local computing device 120, process the data, and direct the data repository 130 to access and/or store data.

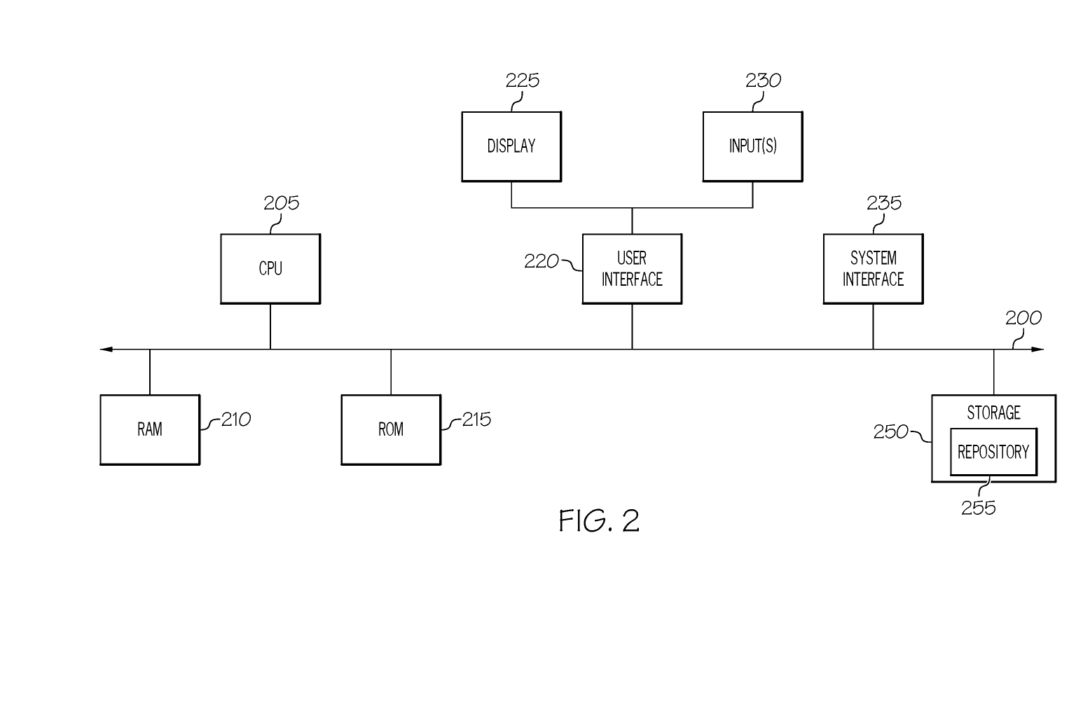

Illustrative hardware components of the local computing device 120 and the remote computing device 125 are depicted in FIG. 2. A bus 200 may interconnect the various components. A processing device 205, such as a computer processing unit (CPU), may be the central processing unit of the computing device, performing calculations and logic operations required to execute a program. The processing device 205, alone or in conjunction with one or more of the other elements disclosed in FIG. 2, is an illustrative processing device, computing device, processor, or combination thereof, as such terms are used within this disclosure. Memory, such as read only memory (ROM) 215 and random access memory (RAM) 210, may constitute illustrative memory devices (i.e., non-transitory processor-readable storage media). Such memory 210, 215 may include one or more programming instructions thereon that, when executed by the CPU 205, cause the CPU 205 to complete various processes, such as the processes described herein. In some embodiments, the program instructions may be stored on a tangible computer-readable medium such as a compact disc, a digital disk, flash memory, a memory card, a USB drive, an optical disc storage medium, such as a Blu-Ray™ disc, and/or other non-transitory processor-readable storage media.

A storage device 250, which may generally be a storage medium that is separate from the RAM 210 and the ROM 215, may contain a repository 255 for storing the various data described herein. For example, the repository 255 may be the data repository 130 that is integrated with the remote computing device 125 (FIG. 1), as described herein. The storage device 250 may be any physical storage medium, including, but not limited to, a hard disk drive (HDD), memory, removable storage, and/or the like. While the storage device 250 is depicted as a local device, it should be understood that the storage device 250 may be a remote storage device, such as, for example, a server computing device, cloud based storage, and/or the like.

An optional user interface 220 may permit information from the bus 200 to be displayed on a display 225 portion of the computing device in a particular format, such as, for example, in audio, visual, graphic, or alphanumeric format. Moreover, the user interface 220 may also include one or more inputs 230 that allow for transmission to and receipt of data from input devices such as a keyboard, a mouse, a joystick, a touch screen, a remote control, a pointing device, a video input device, an audio input device, a haptic feedback device, and/or the like. Such a user interface 220 may be used, for example, to allow a user to interact with one of the computing devices depicted in FIG. 1 or any component thereof.

A system interface 235 may generally provide the computing device with an ability to interface with one or more external components, such as, for example, any of the other computing devices, the imaging device 115 (FIG. 1) (if the computing device is the local computing device 120), and/or the data repository 130 (if the computing device is the remote computing device 125). Communication with external components may occur using various communication ports (not shown), such as, for example, an Ethernet port, a universal serial bus (USB) port, a wireless networking port, and/or the like. An illustrative communication port may be attached to a communications network, such as the Internet, an intranet, a local network, a direct connection, and/or the like, such as, for example, the computer network 105 (FIG. 1).

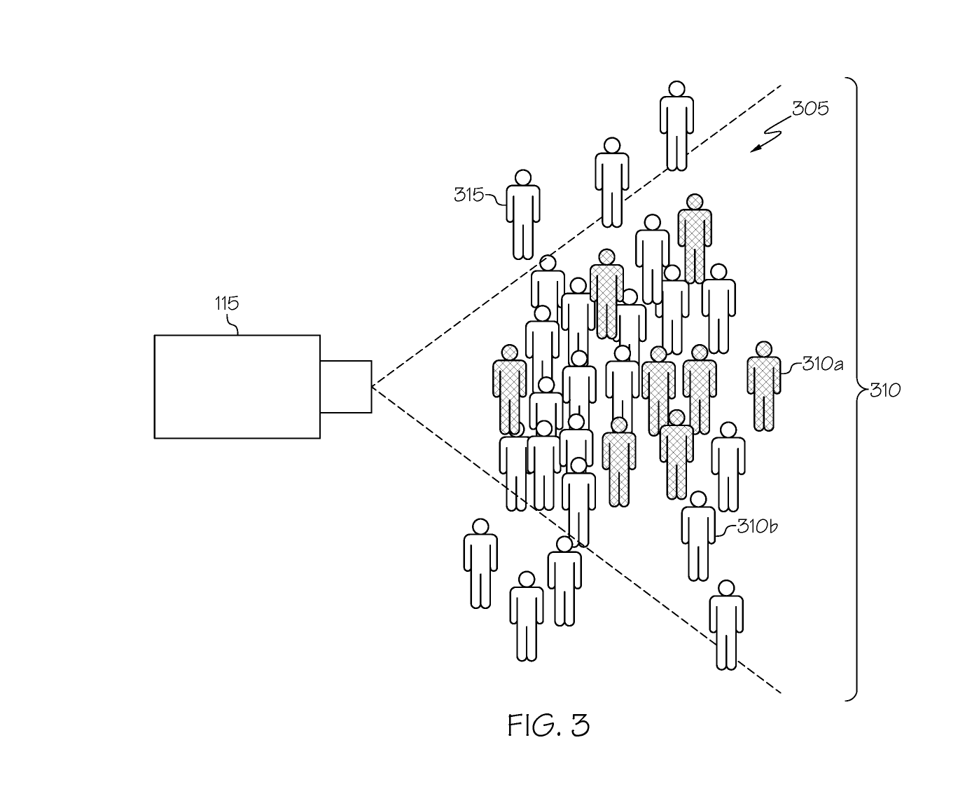

Referring to FIG. 3, a field of view 305 of the imaging device 115 is depicted. The field of view 305 may generally be a maximum angular viewing range for the imaging device 115. That is, the field of view 305 refers to what the imaging device 115 “sees” when it is obtaining image data. Thus, as shown in FIG. 3, the field of view 305 is bounded by the dashed lines; objects located between the dashed lines are within the field of view 305, whereas objects located outside the area bounded by the dashed lines are not within the field of view 305. The field of view 305 may generally be shaped and sized based on various components contained within the imaging device 115. For example, the field of view 305 may be dependent on the size of one or more image sensor portions of the imaging device 115, a range of focal lengths of one or more lenses coupled to the imaging device 115, and/or the like. The shape and size of the field of view 305 is not limited by this disclosure, and may generally be any shapes and/or sizes now known or later developed. In some embodiments, the field of view 305 may be a fixed field of view where the imaging device 115 captures images from a fixed area. In some embodiments, the field of view 305 may be a moving field of view, where movement of the imaging device 115 allows it to capture images from a plurality of different areas. In some embodiments, the field of view 305 may be a panoramic or 360° field of view, where the imaging device 115 contains one or more components that allow it to rotate or otherwise capture a full panoramic or 360° image. In some embodiments, the field of view 305 may be the result of a plurality of imaging devices 115 capturing an image in tandem. In such embodiments, the field of view 305 may be stitched together from the respective individual fields of view of each of the plurality of imaging devices 115.

In various embodiments, one or more present individuals 310 may be located within the field of view 305 of the imaging device 115 and one or more non-present individuals 315 may be located outside the field of view. The one or more non-present individuals 315 may generally be disqualified for the purposes of generating and processing the data as described herein, as they are not imaged by the imaging device 115. Each of the one or more present individuals 310 within the field of view 305 may be an engaged individual 310a or an unengaged individual 310b. An engaged individual 310a may generally be a present individual 310 that is determined to be observing the advertising channel 110 (FIG. 1), as described in greater detail herein. In contrast, an unengaged individual 310b may generally be a present individual 310 that is determined to be not observing the advertising channel 110 (FIG. 1).

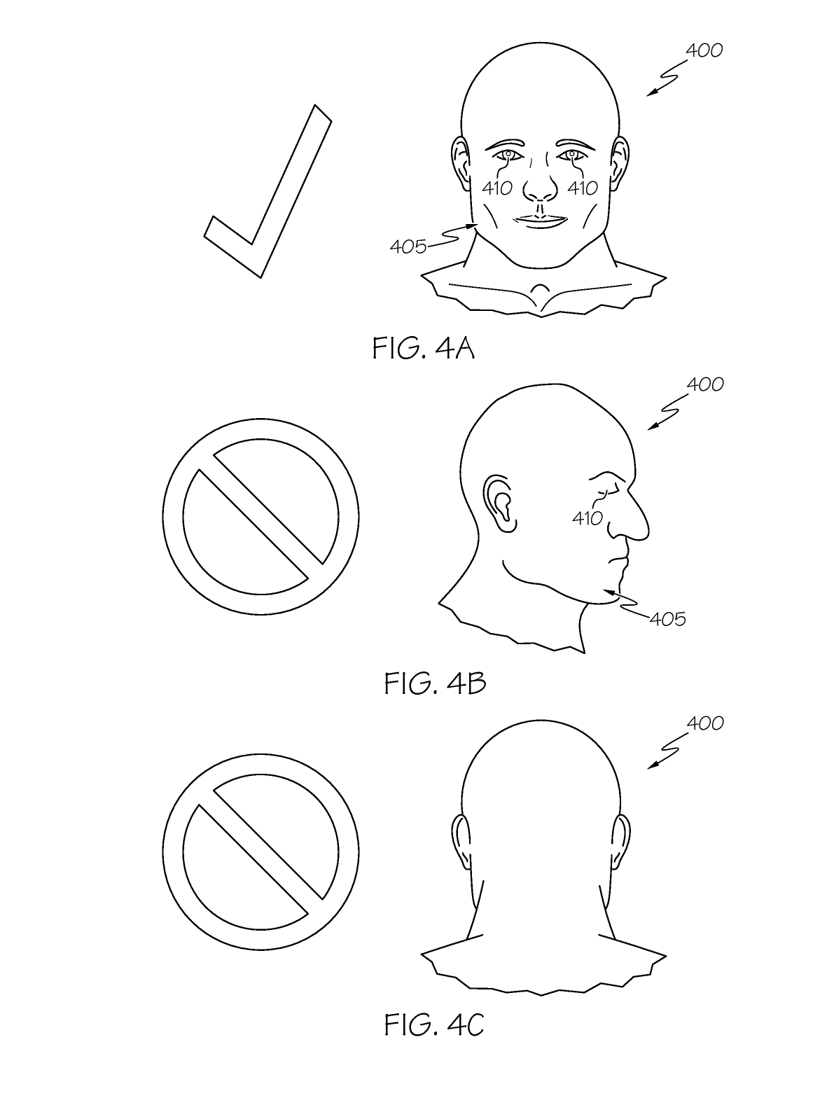

Referring also to FIG. 1, FIGS. 4A-4C depict instances where the imaging device 115 may capture images of individuals in various states of engagement based on whether they are facing the imaging device 115 and the advertising channel 110. As shown in FIG. 4A, an individual 400 may be determined to be an engaged individual 310a if the image captured by the imaging device 115 depicts a face 405 having two eyes 410 facing the imaging device 115. However, as shown in FIG. 4B, if the individual 400 is only partially facing the imaging device 115 such that the captured image only shows a face 405 having a single eye 410 facing the imaging device 115, the individual 400 may be qualified as unengaged individual 310b. Similarly, as shown in FIG. 4C, if the individual 400 is completely facing away from the imaging device 115 such that no face or eyes are captured, the individual 400 may be qualified as an unengaged individual 310b. It should be understood that the examples provided with respect to FIGS. 4A-4C are merely illustrative, and that an individual 400 may be qualified as an engaged individual 310a or an unengaged individual 310b using other determinations without departing from the scope of the present disclosure. For example, an individual 400 may be qualified as an engaged individual 310a if the imaging device 115 is positioned away from the advertising channel 110 (FIG. 1) such that the imaging device 115 captures at least a portion of the advertising channel 110 in the field of view 305 and the individual 400 is determined to be looking at the advertising channel 110, but not facing the imaging device 115. In another example, an individual 400 may be determined to be an engaged individual 310a or an unengaged individual 310b based on certain other facial and/or other body features, such as expression, gaze, and/or the like.

Referring again to FIG. 1, determining an engagement of a user may be completed by the local computing device 120 that is coupled to the imaging device 115 such that image data captured by the imaging device 115 is never transmitted to the remote computing device 125, thereby mitigating or reducing the possibility of violating an individual's privacy. Violating an individual's privacy is mitigated or reduced because no personally identifying information is transferred over the computer network 105. Rather, only data that has been generated by the local computing device 120 is transferred over the computer network 105. Moreover, the generated data cannot be traced back to the image data collected by the imaging device 115 because the image data is purged shortly after it is received by the local computing device 120 (such as by overwriting or deleting the data).

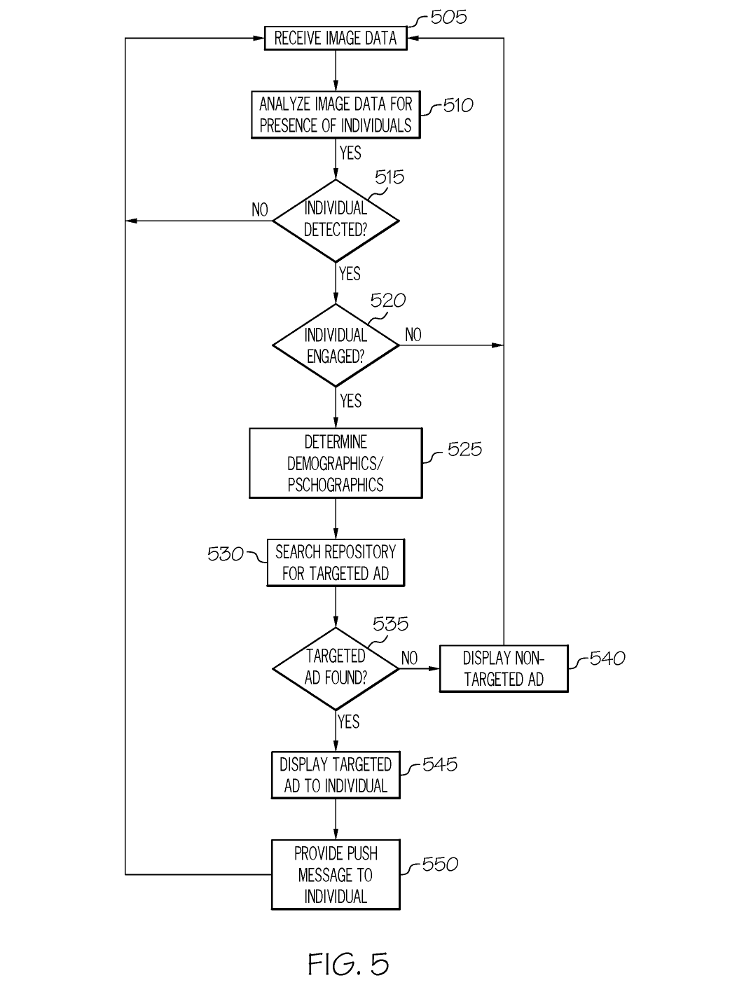

FIG. 5 depicts an illustrative method of providing targeted advertising according on one or more embodiments. In some embodiments, the method described with respect to FIG. 5 may be completed by the local computing device 120 and/or the remote computing device 125, as depicted and described herein with respect to FIG. 1. For the purposes of brevity, the various components completing the steps of FIG. 5 may be referred to as “the system” except where specifically described otherwise.

At step 505, the system may receive image data. For example, the imaging device may be directed to obtain images within its field of view and transmit corresponding image data to the processing device for analysis. As such, the image data may be received from the one or more imaging devices coupled to the local computing device. As previously described herein, the image data may contain information regarding one or more images captured by the one or more imaging devices. For example, the image data may contain one or more images of a field of view of each imaging device at particular time intervals. In another example, the image data may contain a plurality of images in the form of a video clip captured by each imaging device. In some embodiments, the image data may contain information regarding one or more individuals that are at or near the advertising channel. Particularly, the information may include information relating to an orientation of various portions of each individual's body. In addition, the information may include information pertaining to certain features of each individual.

At step 510, the system may analyze the image data for the presence of individuals and determine whether an individual is detected at step 515. For example, the processing device may analyze the image data to determine whether the imaging device has captured an individual within its field of view. In some embodiments, the system may analyze video at a particular frame rate, in particular intervals, at particular time stamps, or the like. In a nonlimiting example, the system may analyze video at 20 frames per second in 3 second intervals and time stamps 1 and 60 (or the third second of the last frame). Determining whether an individual is detected may include discerning between humans and other objects, such as, for example, inanimate objects present within the image data, animals, and/or the like. Discerning between humans and other objects may include determining whether certain features generally associated with humans are present, such as, for example, a head, a torso, one or more limbs, and/or the like. It should be generally recognized that other means of discerning between humans and other objects are included without departing from the scope of the present disclosure. In addition, discerning between humans and other objects may include recognizing that a subject is a live human and not a photograph, a painting, and/or the like. In some embodiments, the system may use any commercially available profile recognition software to discern between humans and other objects.

Certain additional information may be obtained in addition to the determination of whether an individual has been detected, including, but not limited to, whether an individual is a unique individual (i.e., whether the individual passes through the field of view of the imaging device one time, is pacing back and forth in and out of the field of view, and/or the like), a time stamp for when an individual is captured, including when the individual is first captured and when the individual is last captured, a location of the individual (such as a general geographic location, a specific geographic location, a location relative to the advertising channel, a location relative to other individuals, and/or the like), data regarding the imaging device, such as a positioning of the imaging device, a location of the imaging device, a photo capturing mode, a frame rate, and/or the like, information typically contained within RAW data associated with the image data, and/or the like. The total number of individuals and the information associated therewith may be categorized as reach data. The reach data may be used to determine a reaction rate, as described in greater detail herein.

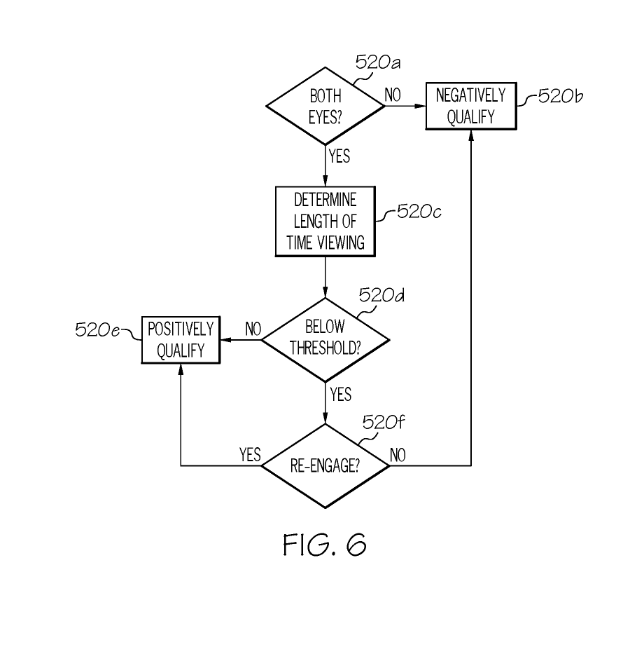

If no individual has been detected, the process may return to step 505 to receive new image data. If an individual has been detected, the process may proceed to step 520. At step 520, a determination may be made as to whether the individual is engaged. More specifically, such a determination may be based on whether the individual is facing the advertising channel for a particular period of time and/or if the individual is exhibiting certain body language indicative of engagement. Determining whether an individual is engaged may include analyzing the image data to determine an orientation of each individual's head, an individual's gaze, an individual's expression, an individual's body movement, and/or the like. For example, as shown in FIG. 6, the system may determine whether both of the individual's eyes are visible in the image data in step 520a. Presence of both of the eyes may be indicative that the individual is facing the imaging device, and thus the advertising channel. In contrast, presence of neither eye or only one eye may be indicative that the individual is not facing the imaging device, and thus not facing the advertising channel. If both of the individual's eyes are not visible, the system may negatively qualify the individual in step 520b and determine the individual is not engaged.

If both of the individuals eyes are visible, the system may determine the length of time the individual is facing the imaging device (and is assumed to be viewing the advertising channel) in step 520c. In some embodiments, an individual may be negatively qualified if the duration of engagement is less than a threshold time. Thus, as shown in step 520d, the system may determine whether the length of time is below the threshold. The threshold time is not limited by this disclosure, and may generally include any time. In some embodiments, the threshold time may be about 1 second. In some embodiments, the threshold time may be set by an administrator and based on preferences of the administrator.

If the length of time is greater than the threshold, the individual may be positively qualified in step 520e and determined to be engaged. If the length of time is less than the threshold, the system may determine whether the individual becomes reengaged in step 520f. An individual may become reengaged if he or she views the advertising channel again within a certain time period. For example, if the individual becomes distracted and momentarily glances away from the advertising channel, but then returns to viewing the advertising channel within a certain time period, the individual may be determined to be reengaged. The time period is not limited by this disclosure, and may be any time. For example, in some embodiments, the time period may be about 30 seconds to about 10 minutes, including about 30 seconds, about 1 minute, about 2 minutes, about 3 minutes, about 4 minutes, about 5 minutes, about 6 minutes, about 7 minutes, about 8 minutes, about 9 minutes, about 10 minutes, or any value or range between any two of these values (including endpoints). In some embodiments, the time period may be set by an administrator and based on preferences of the administrator.

If the individual becomes reengaged within the time period, the individual may be positively qualified in step 520e and determined to be engaged. If the individual does not become reengaged within the time period, the individual may be negatively qualified in step 520b.

Referring again to FIG. 5, if the individual is determined to not be engaged, the process may return to step 505 to receive new image data. If the individual is determined to be engaged, the process may proceed to step 525.

At step 525, certain demographic and/or psychographic features of the engaged individual may be determined. For example, the system may determine demographic information such as an age, a sex, a race, and/or the like of the individual. Such a determination may be completed by determining various features from an individual (e.g., facial features) and accessing a database to obtain demographic information associated with such features. For example, if an individual has a particular skin tone, a database may contain information that might associate that skin tone to a particular race. It should be understood that other demographic features other than age, sex, race, and the like that are not specifically described herein are also included within the scope of the present disclosure. Psychographic features may include any indication of the individual's personality, values, opinions, attitudes, aspirations, interests, and lifestyles. That is, while demographic features may explain who an individual is, psychographic features may explain why an individual does certain things, has certain feelings, and/or the like. Psychographic information may be determined based on how the individual is dressed, how the individual acts, whether the individual is carrying any objects, the individual's transportation, and/or the like. For example, if an individual is wearing a certain brand of clothing, a certain psychographic trait may be determined based on that brand of clothing worn. More specifically, an individual wearing luxury brand items may have different psychographic traits than an individual wearing discount brand items or items that do not have a brand name associated therewith. In another example, license plate data may be accessed to determine the make, model, and type of vehicle an individual is driving, which could potentially be used to determine certain psychographic traits. More specifically, if received data indicates that an individual is driving a vehicle that runs on alternative fuels, such data may be indicative of certain psychographic traits such as eco-conciousness. Other psychographic information not specifically described herein may also be determined without departing from the scope of the present disclosure. In addition to demographic and/or psychographic information, the individual's emotions, gaze, and/or the like may also be determined. For example, if the individual appears to be upset, which may be determined based on known facial characteristics indicative of sadness, such an emotion of sadness may be recorded in addition to the demographic and psychographic information.

In some embodiments, determining a demographic and/or psychographic may also include connecting to the individual's mobile device or other personal device and searching a repository for information regarding the individual. For example, the individual may have a mobile device with a software application installed thereon. The software application may be configured such that the individual has previously provided consent to be monitored, and certain monitored data may be obtained pursuant to the provided consent. For example, the user may have consented to allow monitoring of web browsing activity on the mobile device. The web browsing history can be obtained and a determination may be made as to whether the web browsing history contains information that may be demographic and/or psychographic information or pertinent to demographic and/or psychographic information. For example, a questionnaire completed by the individual on the mobile device may contain demographic and/or psychographic information.

The system may search a repository for a targeted ad at step 530 and may determine whether a targeted ad that applies to the engaged individual has been found at step 535. If the demographic and/or psychographic features of the engaged individual can be classified to a particular classification, and the particular classification has particular advertisements linked to it, a determination may be made that a targeted ad that fits the engaged individual has been found. For example, if the demographic and/or psychographic features indicate that the individual is likely to be interested in a particular topic (e.g., baby products), the repository may be searched for ads relating to that particular topic (e.g., diapers). If the demographic and/or psychographic features of the engaged individual cannot be classified to a particular classification or if the particular classification does not have particular advertisements linked to it, a determination may be made that a targeted ad has not been found.

In some embodiments, if no targeted ad is found, a non-targeted ad may be displayed at step 540 and the process may return to step 505 to receive new image data. That is, an advertisement may be displayed to the individual that may or may not match the individual's interests. For example, a most common or most popular ad may be displayed to the individual. In other embodiments, if no target ad is found, no ad may be displayed. That is, instead of displaying a non-targeted ad, the process may bypass step 540 and return to step 505 to receive new image data.

If a targeted ad is found, the targeted ad may be provided to the individual at step 545. The targeted ad may be displayed, for example, by the advertising channel (e.g., a display device or the like). That is, the advertising channel may provide a pictographic representation of the targeted ad to the individual, a video representation of the targeted ad to the individual, and/or the like. In some embodiments, the targeted ad may be specifically customized to the individual. For example, the targeted ad may display the individual's name or other information to indicate to the individual that the targeted ad is intended for him/her. In some embodiments, a push message may be provided to the individual at step 550. The push message may be delivered electronically or manually. For example, the push message may be pushed to the individual's mobile device via any technology now known or later developed. For example, the message may be pushed via an NFC transmission, an RFID tag, a Bluetooth connection, and/or the like. In another example, the message may be pushed via a service such as Apple® iBeacon®, beacons transmitted via Google® Eddystone™, and/or the like. The message may be additional advertising, a coupon, a URL to a website, and/or the like.

In some embodiments, the targeted ad may include a notification that directs the user to check his/her mobile device to accept the push message. For example, the targeted ad may display a message that indicates to the individual to check his/her mobile device. In some embodiments, the targeted ad that is displayed at the advertising channel may be interactive so as to further engage the individual (e.g., the advertising channel is a touchscreen or the like). For example, the individual may interact with the targeted ad to obtain additional information about a product or service, download a coupon, contact a representative, and/or the like.

It should now be understood that the devices and methods described herein capture image data at or near an advertising channel, determine whether individuals present in the image data are engaged, determine corresponding demographic and/or psychographic features of the engaged individual, and provide targeted advertising to the individual based on the demographic and/or psychographic features.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An advertising system comprising:
an advertising channel;
one or more imaging devices that obtain image data, wherein the image data contains images captured at or near an advertising channel; and
a computing device that:
analyzes the image data to determine that one or more individuals are present at or near the advertising channel,
determines that at least one individual of the one or more individuals present at or near the advertising channel are engaged with the advertising channel, and
determines at least one of:
one or more demographic features of the at least one individual, and
one or more psychographic features of the at least one individual,
wherein the advertising channel provides a targeted ad to the at least one individual based on at least one of:
the one or more demographic features of the at least one individual, and
the one or more psychographic features of the at least one individual.

2. The advertising system of claim 1, further comprising a remote computing device communicatively coupled to the advertising channel via a computer network.

3. The advertising system of claim 1, further comprising a data repository coupled to the advertising channel via a computer network.

4. The advertising system of claim 3, wherein the data repository stores at least one of:
the image data;
data relating to the one or more demographic features of the at least one individual;
data relating to the one or more psychographic features of the at least one individual; and
targeted advertising data.

5. The advertising system of claim 1, wherein the advertising channel comprises the one or more imaging devices and the computing device.

6. The advertising system of claim 1, wherein the advertising channel comprises an out-of-home advertising channel or an in-home advertising channel.

7. The advertising system of claim 1, wherein the advertising channel comprises at least one of a poster, a billboard, and a wall scape.

8. The advertising system of claim 1, wherein the advertising channel provides a non-targeted ad to the at least one individual when no targeted ad corresponds to the at least one of:
the one or more demographic features of the at least one individual, and
the one or more psychographic features of the at least one individual.

9. The advertising system of claim 1, wherein the one or more psychographic features are obtained based on an imaged license plate of a vehicle driven by the at least one individual.

10. An advertising device comprising:
a processing device; and
a non-transitory, processor-readable storage medium, wherein the non-transitory, processor-readable storage medium comprises one or more programming instructions thereon that, when executed, cause the processing device to:
receive image data from one or more imaging devices, wherein the image data contains images captured at or near an advertising channel,
analyze the image data to determine that one or more individuals are present at or near the advertising channel,
determine that at least one individual of the one or more individuals present at or near the advertising channel is engaged with the advertising channel,
determine at least one of:
one or more demographic features of the at least one individual, and
one or more psychographic features of the at least one individual, and
provide a targeted ad to the at least one individual based on at least one of:
the one or more demographic features of the at least one individual, and
the one or more psychographic features of the at least one individual.

11. The advertising device of claim 10, further comprising at least one of the one or more imaging devices and the advertising channel.

12. The advertising device of claim 10, wherein the one or more programming instructions that, when executed, cause the processing device to determine that the at least one individual is engaged with the advertising channel further cause the processing device to:
determine an amount of time in which the at least one individual is facing the advertising channel;
when the at least one individual is facing the advertising channel for a period of time that is less than a threshold amount, negatively qualify the at least one individual; and
when the at least one individual is facing the advertising channel for a period of time that is greater than or equal to the threshold amount, positively qualify the at least one individual.

13. The advertising device of claim 12, wherein the threshold amount is one second.

14. The advertising device of claim 10, wherein the one or more programming instructions that, when executed, cause the processing device to receive image data from the one or more imaging devices further cause the processing device to continuously receive image data from the one or more imaging devices.

15. The advertising device of claim 10, wherein the non-transitory, processor-readable storage medium further comprises one or more additional programming instructions thereon that, when executed, cause the processing device to:
determine that no targeted ad exists for the at least one individual based on at least one of:
the one or more demographic features of the at least one individual, and
the one or more psychographic features of the at least one individual; and
provide a non-targeted ad to the at least one individual.

16. A method of providing a targeted ad to an individual, the method comprising:
receiving, by a processing device, image data from one or more imaging devices, wherein the image data contains images captured at or near an advertising channel;
analyzing, by the processing device, the image data to determine that one or more individuals are present at or near the advertising channel;
determining, by the processing device, that at least one individual of the one or more individuals present at or near the advertising channel is engaged with the advertising channel;
determining, by the processing device, at least one of:
one or more demographic features of the at least one individual, and
one or more psychographic features of the at least one individual, and
providing, by the processing device, a targeted ad to the at least one individual based on at least one of:
the one or more demographic features of the at least one individual, and
the one or more psychographic features of the at least one individual.

17. The method of claim 16, wherein determining that the at least one individual is engaged with the advertising channel further comprises:
determining, by the processing device, an amount of time in which the individual is facing the advertising channel;
when the individual is facing the advertising channel for a period of time that is less than a threshold amount, negatively qualifying the individual; and
when the individual is facing the advertising channel for a period of time that is greater than or equal to the threshold amount, positively qualifying the individual.

18. The method of claim 16, wherein determining at least one of the one or more demographic features and the one or more psychographic features comprises extracting at least one of the one or more demographic features and the one or more psychographic features from an image of a license plate associated with a vehicle driven by the individual.

19. The method of claim 16, wherein receiving the image data from the one or more imaging devices further comprises continuously receiving, by the processing device, image data from the one or more imaging devices.

20. The method of claim 16, further comprising:
determining, by the processing device, that no targeted ad exists for the individual based on at least one of:
the one or more demographic features of the at least one individual, and
the one or more psychographic features of the at least one individual; and
providing a non-targeted ad to the individual.
